(19) United States
(12) Patent Application Publication
(10) Pub. No.: US 2014/0165961 A1
(43) Pub. Date: Jun. 19, 2014

(54) ACTIVE PLURAL INLET AIR INDUCTION SYSTEM

(71) Applicants: Dipak Patel, Grand Blanc, MI (US); Ryan P. Schrieber, Livonia, MI (US); Jason D. Shawver, Waterford, MI (US); Kevin G. Mets, Washington, MI (US); Rodney R. Romain, II, Algonac, MI (US); Otto A. Wilhelm, JR., Chesterfield Township, MI (US)

(72) Inventors: Dipak Patel, Grand Blanc, MI (US); Ryan P. Schrieber, Livonia, MI (US); Jason D. Shawver, Waterford, MI (US); Kevin G. Mets, Washington, MI (US); Rodney R. Romain, II, Algonac, MI (US); Otto A. Wilhelm, JR., Chesterfield Township, MI (US)

(21) Appl. No.: 13/720,263

(22) Filed: Dec. 19, 2012

(51) Int. Cl. F02D 41/00

(52) U.S. Cl. CPC F02D 41/0002
USPC 123/337; 123/184.21

(57) ABSTRACT

An air intake system includes a first inlet and a first valve member that moves between an open position and a closed position to regulate flow through a first passage toward a manifold. The first valve member is biased toward the open position. The system also includes a second inlet and a second valve member that moves between an open position and a closed position to regulate flow through a second passage toward the manifold. The second valve member is biased toward the closed position. Moreover, the system includes a sensor that detects a condition of the vehicle and a controller that simultaneously causes the first valve member to move toward the closed position and the second valve member to move toward the open position when the sensor detects the condition.

### FIELD

The present disclosure relates to an air induction system and, more particularly, relates to an active plural inlet air induction system of a vehicle.

### BACKGROUND

Vehicles with internal combustion engines typically include an air intake system that draws air from outside the vehicle into the engine. This air can mix with fuel, and the air/fuel mixture can be combusted within a cylinder of the engine. This energy can drive a piston within the cylinder, which can thereby drivingly rotate a main shaft of the vehicle. The shaft can drivingly rotate the wheels of the vehicle.

The vehicle can be configured for operation in a variety of conditions. For instance, the vehicle can operate in high ambient temperatures, low ambient temperatures, during rain or snow storms, and other environmental conditions. The engine of the vehicle can also be affected by certain conditions. For instance, the engine can have a higher load when the vehicle is towing as compared to when the vehicle is not towing an object. Similarly, the engine can have a higher load when the vehicle is climbing a steep grade as compared to travelling downhill. Existing air intake systems can be configured for directing air toward the engine in these conditions.

### SUMMARY

An air intake system for a vehicle is disclosed that includes a first inlet defining a first passage that leads to a manifold. The system also includes a first valve member that is operably mounted to the first inlet and that moves between an open position and a closed position to regulate flow through the first passage toward the manifold. The first valve member is biased toward the open position. The system also includes a second inlet defining a second passage that leads to the manifold and a second valve member that is operably mounted to the second inlet and that moves between an open position and a closed position to regulate flow through the second passage toward the manifold. The second valve member is biased toward the closed position. Moreover, the system includes a sensor that detects a condition of the vehicle and a controller that simultaneously causes the first valve member to move toward the closed position and the second valve member to move toward the open position when the sensor detects the condition.

Also, a method of operating an air intake system of a vehicle is disclosed that includes providing a first valve member and a second valve member. The first valve member is moveably mounted to a first inlet that defines a first passage that leads to a manifold, and the first valve member is operable to move between a closed position and an open position. The first valve member is biased toward the open position, and the second valve member is moveably mounted to a second inlet that defines a second passage that leads to the manifold. The second valve member is operable to move between a closed position and an open position, and the second valve member is biased toward the closed position. Moreover, the method includes determining whether a predetermined condition of the vehicle exists and simultaneously moving the first valve member toward the closed position and the second valve member toward the open position in response to a determination that the predetermined condition of the vehicle exists

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of a vehicle with an air intake system according to exemplary embodiments of the present disclosure;

FIG. 2 is a perspective view of the air intake system of FIG. 1 with portions of the vehicle shown in phantom;

FIG. 3 is a top view of the air intake system of FIG. 1, wherein a top of a manifold of the system is removed;

FIG. 4 is a section view of the air intake system taken along the line 4-4 of FIG. 3, wherein the system is shown in a default mode;

FIG. 5 is a section view of the air intake system shown in a secondary mode; and

FIG. 6 is a method of operating the air intake system according to exemplary embodiments of the present disclosure.

### DETAILED DESCRIPTION

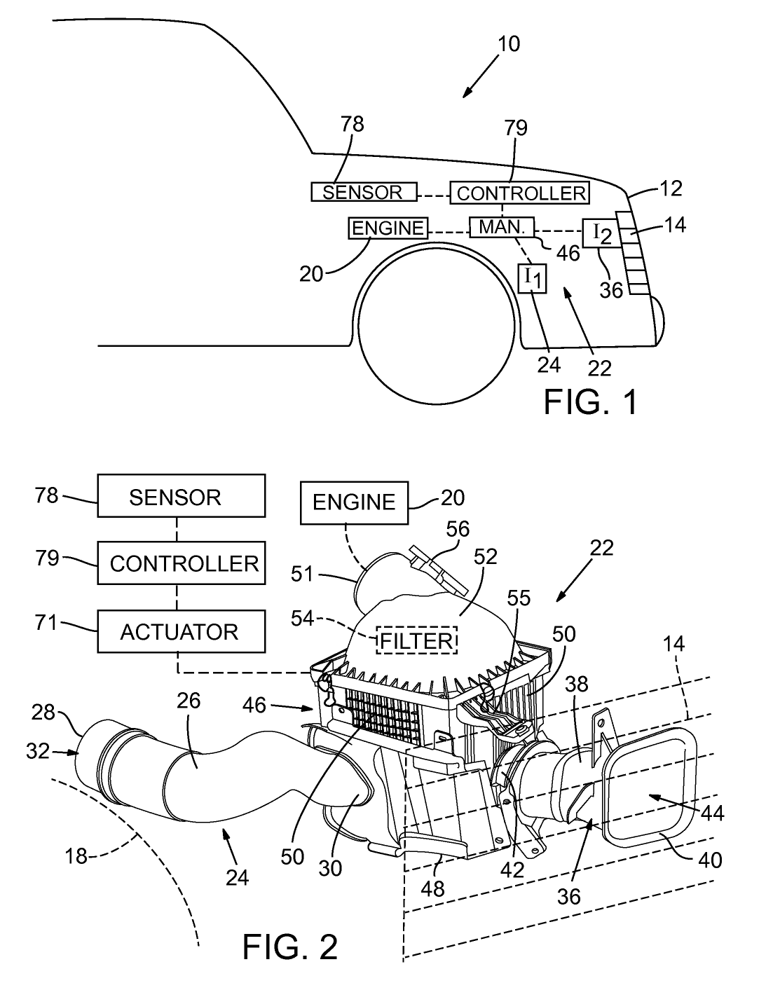

Referring initially to FIG. 1, a vehicle 10 is illustrated with an air intake system 22 according to exemplary embodiments of the present disclosure. The vehicle 10 can be a car, truck, van, sports utility vehicle, or other type. The vehicle 10 can also define a front end 12 with a grill 14 and a side 16 (e.g., a passenger side) with a wheel well 18 defined thereon. The vehicle 10 can additionally include an internal combustion engine 20 (e.g., a diesel or gas engine) that receives air via the air intake system 22. As will be discussed, the air intake system 22 can be actively controlled to switch between multiple modes, depending on whether or not certain predetermined conditions exist. As such, the engine 20 and/or other vehicle systems can operate efficiently.

The intake system 22 can generally include a first inlet 24 that is defined by a first pipe 26. The first pipe 26 can include an upstream end 28, a downstream end 30, and a first passage 32 extending longitudinally therethrough. The first passage 32 can have any suitable cross sectional shape and size. Also, the first passage 32 can be longitudinally straight or can curve in any suitable direction.

The intake system 22 can further include a second inlet 36 that is defined by a second pipe 38. The second pipe 38 can include an upstream end 40, a downstream end 42, and a second passage 44 extending longitudinally therethrough. The second passage 44 can have any suitable cross sectional shape and size. Also, the second passage 44 can be longitudinally straight or can curve in any suitable direction.

In the embodiments illustrated in FIG. 2, the upstream end 28 of the first inlet 24 can generally toward the rear of the vehicle 10 and can be disposed adjacent the wheel well 18. (The wheel well 18 is shown schematically in FIG. 2 with a curved broken line.) Accordingly, the upstream end 28 can receive and draw air from inside the wheel well 18, and this air can flow downstream through the first inlet 24. Moreover, the upstream end 40 of the second inlet 36 can be face generally forward and can be partially covered by the grill 14 at the forward end of the vehicle 10. (The grill 14 is shown schematically in FIG. 2 with broken lines.) Accordingly, the upstream end 40 of the second inlet 36 can draw air inward through the grill 14, and this air can flow downstream through the second inlet 36.

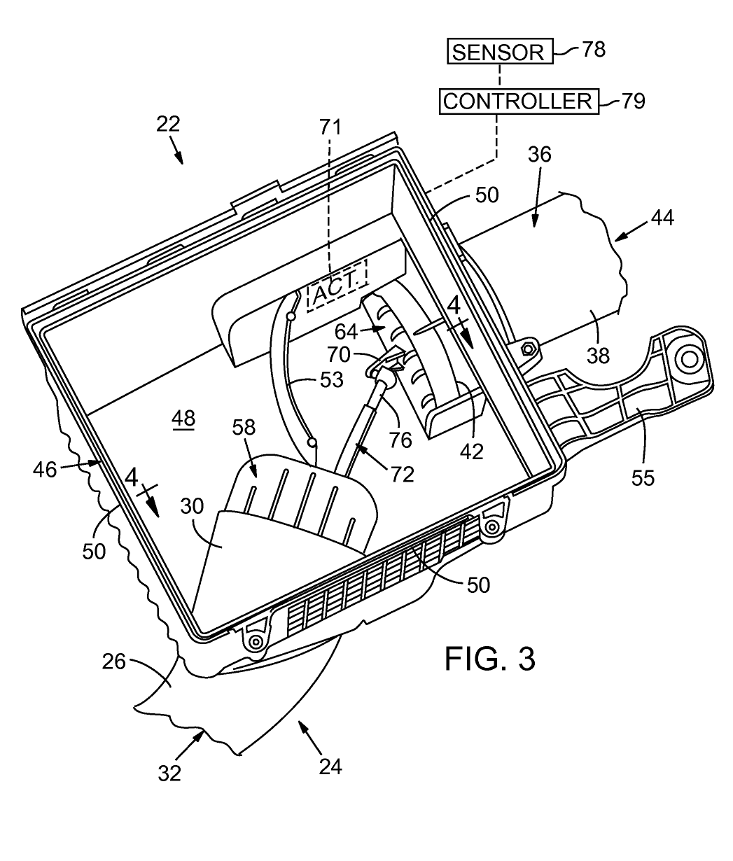

Both the downstream end 30 of the first inlet 24 and the downstream end 42 of the second inlet 36 can communicate with and terminate at a manifold 46. As shown in FIGS. 2 and 3, the manifold 46 can be substantially box-shaped and hollow. Thus, the manifold 46 can include a bottom wall 48, a plurality of side walls 50 (e.g., four side walls 50), and a top 52. (The top 52 is removed in FIG. 3.) The downstream ends 30, 42 of the inlets 24, 36 can communicate into the manifold 46 through different side walls 50 (e.g., perpendicular side walls 50).

Furthermore, the top 52 can include an outlet 51 defined therein. Also, as shown schematically in FIG. 2, an air filter 54 can be supported within the manifold 46 (e.g., supported by the top 52 of the manifold 46). Thus, air that enters the manifold 46 through either inlet 24, 36 can flow through the filter 54 such that particulate or other debris can be filtered therefrom, and this air can flow out of the manifold 46 via the outlet 51.

Additionally, the intake system 22 can include a mass airflow sensor 56 (FIG. 2). In the embodiments illustrated, the sensor 56 can be operably supported adjacent the outlet 51. The sensor 56 can be operable to detect the mass airflow exiting the manifold 46 through the outlet 51. Also, as shown in FIG. 3, the manifold 46 can include an internal wall 53. In the embodiments illustrated, the internal wall 53 extends upwardly from the bottom wall 48. Also, the internal wall 53 can be curved between opposing sidewalls 50 of the manifold 46. Specifically, the wall 53 can curve concavely and generally face the downstream end 42 of the second inlet 36. The internal wall 53 can direct airflow within the manifold 46, and in some embodiments, the internal wall 53 can ensure that the mass airflow sensor 56 operates accurately. For instance, the internal wall 53 can ensure that the mass airflow sensor 56 is within a substantially similar airflow regardless of whether air is entering the manifold 46 through the first inlet 24 or the second inlet 36.

Still further, the intake system 22 can include one or more brackets 55 (FIG. 2) that can secure the manifold 46 and/or the inlets 24, 36 to the vehicle 10. One bracket 55 is indicated in FIG. 2 that extends horizontally and forwardly from the manifold 46. This bracket 55 can be fixedly attached to any suitable surrounding structure (e.g., by fasteners, etc.) to thereby fix the manifold 46 to the vehicle 10. The manifold 46, the first inlet 24, and/or the second inlet 36 can include any number of additional brackets 55 for securing the same to the vehicle 10.

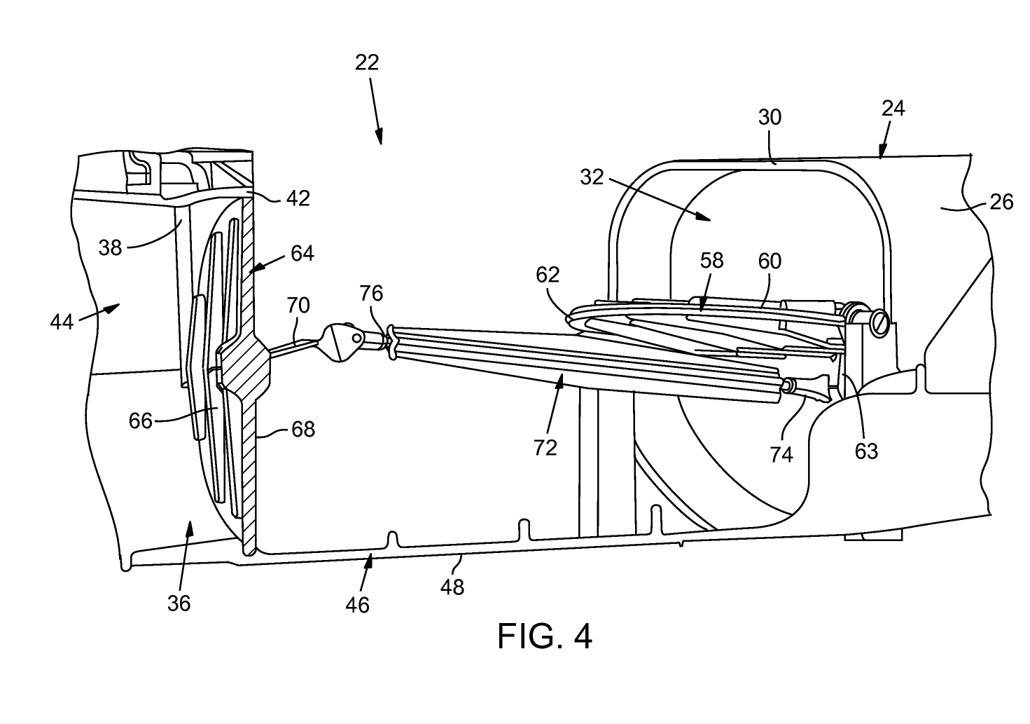

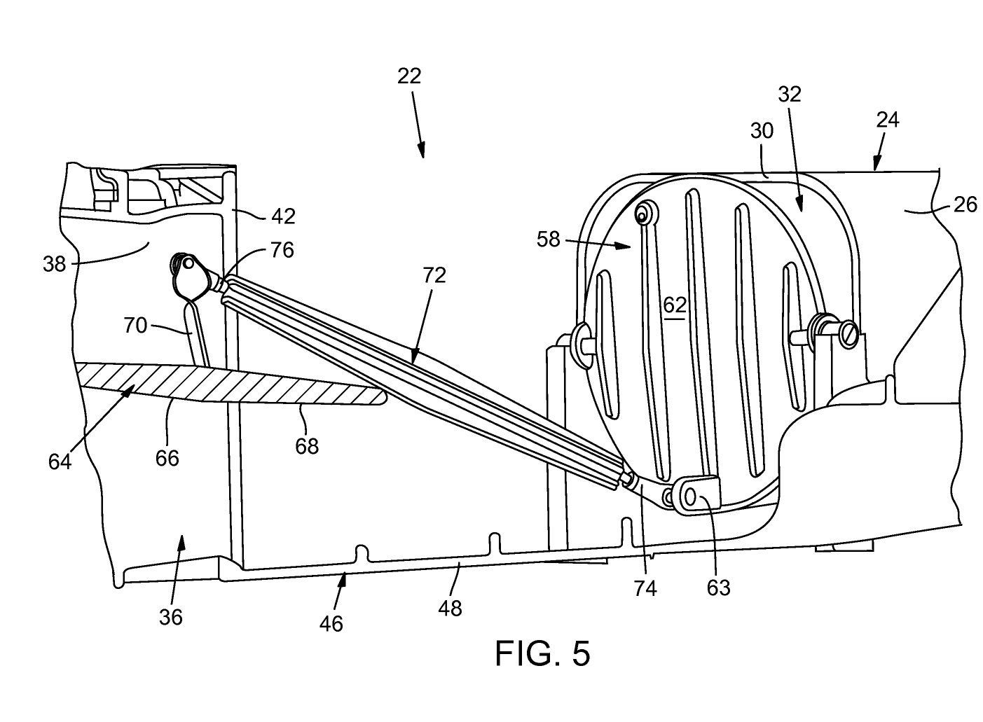

Moreover, as shown in FIGS. 3, 4, and 5, the intake system 22 can also include a first valve member 58. The first valve member 58 can be a flat plate that can have approximately the same size and shape as the cross sectional area of the downstream end 30 of the first pipe 26. The first valve member 58 can include an upstream face 60 and a downstream face 62. The first valve member 58 can also include a projection 63 (FIG. 5) that projects from the downstream face 62. The first valve member 58 can be moveably attached (e.g., pivotally attached) to the manifold 46, adjacent to the downstream end 30 of the first pipe 26, to thereby move between an open position (FIG. 4) and a closed position (FIG. 5). In the embodiments illustrated, the first valve member 58 can pivot about an axis that is substantially horizontal relative to the vehicle 10. When closed, the first valve member 58 can substantially block and cover the downstream end 30. When open, the first valve member 58 can be substantially parallel to the axis of the downstream end 30.

Moreover, the intake system 22 can also include a second valve member 64. The second valve member 64 can be a flat plate that can have approximately the same size and shape as the cross sectional area of the downstream end 42 of the second pipe 38. The second valve member 64 can include an upstream face 66 and a downstream face 68. The second valve member 64 can also include a projection 70 (FIGS. 3 and 4) that projects from the downstream face 68. The second valve member 64 can be moveably attached (e.g., pivotally attached) to the manifold 46, adjacent to the downstream end 42 of the second pipe 38, to thereby move between an open position (FIG. 5) and a closed position (FIG. 4). In the embodiments illustrated, the second valve member 64 can pivot about an axis that is substantially horizontal relative to the vehicle 10. When closed, the second valve member 64 can substantially block and cover the downstream end 42. When open, the second valve member 64 can be substantially parallel to the axis of the downstream end 42.

Additionally, the intake system 22 can include a linkage 72. In the embodiments illustrated, the linkage 72 can be an elongate, rigid rod with a first portion 74 that is operably attached (e.g., pivotally attached) to the projection 63 and a second portion 76 that is operably attached (e.g., pivotally attached) to the projection 70. Thus, as will be explained, the linkage 72 can cause the first and second valve members 58, 64 to move simultaneously. For instance, as the first valve member 58 moves from its open position to its closed position, the second valve member 58 can move in tandem from its closed position to its open position due to the attachment provided by the linkage 72.

Furthermore, the system 22 can include an actuator 71. The actuator 71 can be housed within one of the sidewalls 50 of the manifold 46 as shown schematically in FIG. 3. The actuator 71 can be an electric motor, a hydraulic actuator, a pneumatic actuator, or can be of any other suitable type. In the embodiments shown, the actuator 71 is operably and directly connected to the second valve member 64 (e.g., to the axle that pivotally supports the second valve member 64). Thus, the actuator 71 can drivingly rotate the second valve member 64 between its open and closed positions, and the linkage 72 can consequently push or pull the first valve member 58 between its open and closed positions.

Additionally, the system 22 can include a sensor 78. The sensor 78 can be operable for detecting any type of vehicle condition. For instance, the sensor 78 could be a temperature sensor that detects ambient temperature, engine coolant temperature, or any other temperature affecting the vehicle 10. The sensor 78 could also be a pressure sensor that detects barometric pressure, coolant pressure, or any other pressure affecting the vehicle 10. The sensor 78 could also be operable for detecting other predetermined conditions as will be discussed.

Moreover, the system 22 can include a controller 79 (i.e., a processor) that is in operative communication with the sensor 78. The controller 79 can receive electronic or other signals from the sensor 78 and can consequently transmit control signals to the actuator 71 for controlling the respective positions of the first and second valve members 58, 64. Thus, as will be described, if the sensor 78 detects that a certain condition exists, then the controller 79 can move the first valve member 58 to its open position and the second valve member 64 to its closed position. On the other hand, if the sensor 78 detects that another condition exists, then the controller 79 can move the first valve member 58 to its closed position and the second valve member 64 to its open position.

It will be appreciated that the valve members 58, 64 could be configured such that one valve member 58, 64 is biased toward the open position and the other is biased toward the closed position. For instance, a torsion spring or other biasing member could provide such biasing force. Also, in some embodiments, the actuator 71 could be configured such that the actuator 71 provides this biasing force when de-energized. In the embodiments illustrated, for instance, the first valve member 58 is biased toward its open position, while the second valve member 64 is biased toward its closed position. This can be referred to as the “Default Mode” of the system 22 (i.e., the mode that the system 22 defaults to and, thus, the mode that the system 22 is in during normal driving conditions). As such, air can flow through the first inlet 24 and is substantially blocked from flowing through the second inlet 36 to the manifold 46.

Also, the intake system 22 can have a “Secondary Mode,” which is opposite the “Default Mode.” For instance, in some embodiments, the second valve member 64 can be open while the first valve member 58 is substantially closed in some embodiments of the “Secondary Mode.” (This “Secondary Mode” can also be referred to as a “Ram Air Mode.”) The system 22 can switch to this “Secondary Mode” under certain predetermined circumstances as will be discussed in detail below.

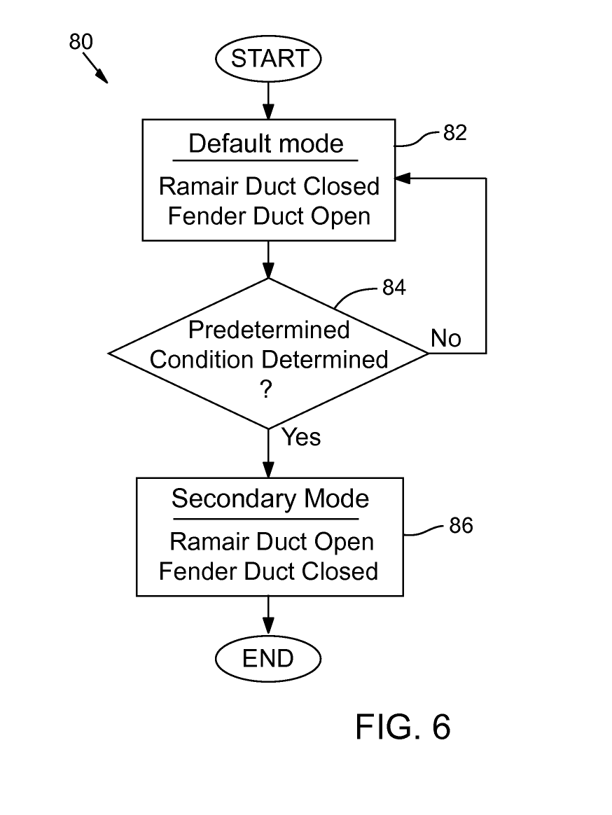

Referring now to FIG. 6, a method 80 of operating the intake system 22 is illustrated according to various exemplary embodiments. As shown, the method 80 can begin in block 82, wherein the system 10 defaults to its “Default Mode.” This can occur upon engine start-up in some embodiments.

Then, in block 84, the controller 79 can determine whether any of the predetermined conditions exist. The controller 79 can rely on the readings from the sensor 78 to make this determination. For instance, the controller 79 can have one or more predetermined thresholds (e.g., temperature limits, pressure limits, etc.) stored in memory, the sensor 78 can take appropriate readings (e.g., temperature readings, pressure readings, etc.), and the controller 79 can compare the readings supplied by the sensor 78 to the saved thresholds to see if any of the readings exceed the thresholds to thereby determine if the predetermined condition exists.

If the predetermined condition does not exist as determined in block 84 (block 84 answered negatively), then the method 80 can loop back to block 82 and the system 22 can remain in the “Default Mode.” However, if the predetermined condition does exist (block 84 answered positively), then the method 80 can continue to block 86. In block 86, the system 22 can switch to its “Secondary Mode.” To switch, the controller 79 can command the actuator 71 to drive the second valve member 64 to rotate from its closed position to its open position, and this movement can consequently and simultaneously move the first valve member 58 to rotate from its open position to its closed position.

The system 22 can remain in this “Secondary Mode” until the predetermined condition of block 84 no longer exists. Also, in some embodiments, the system 22 can remain in this “Secondary Mode” until the engine of the vehicle 10 is turned off, and upon re-start, the system 22 can return to its “Default Mode.”

It will be appreciated that the system 22 can switch between the “Default Mode” and the “Secondary Mode” upon determination of any suitable predetermined condition. Generally, the system 22 can switch from the “Default Mode” to the “Secondary Mode” when the vehicle 10 is operating in high temperature conditions, when travelling at relatively high speeds, when towing a trailer or other load, etc. Thus, in winter or during low ambient temperatures, the “Default Mode” can allow warmer air near the wheel well 18 to flow through the first inlet 24 and to avoid build-up of snow and water in the manifold 46. On the other hand, during summer, the system 22 can switch to the “Secondary Mode” to allow cooler air through the second inlet 36 into the manifold 46 for better engine performance.

In some embodiments, the system 22 can switch from the “Default Mode” to the “Secondary Mode” when the controller 79 determines that the coil-out temperature exceeds a threshold (e.g., 425° F., etc.). Also, the system 22 can switch from the “Default Mode” to the “Secondary Mode” when the controller 79 determines that the coil-out temperature is above a threshold (e.g., 325° F., etc.) in combination with a rise-over-ambient temperature over a threshold (e.g., 30° F., etc.). Furthermore, the system 22 can switch from the “Default Mode” to the “Secondary Mode” when the controller 79 determines that the vehicle speed is above a predetermined threshold (e.g., above 20 mph, etc.). Additionally, the system 22 can switch from the “Default Mode” to the “Secondary Mode” when the controller 79 determines that the ambient temperature is above a predetermined threshold (e.g., above 40° F., etc.).

Moreover, in a specific example, the system 22 can switch from the “Default Mode” to the “Secondary Mode” when the controller 79 determines that the coil-out threshold is above 325° F., with rise-over-ambient temperature above 30° F., with a vehicle speed above 20 mph, and an ambient temperature over 40° F. If one or more of these conditions does not exist, then the system 22 can remain in or can switch back to the “Default Mode.”

The controller 79 can look for other conditions for determining whether to switch from the “Default Mode” to the “Secondary Mode.” For instance, the controller 79 can make this determination based on the ambient temperature, humidity, whether there is rainfall or other precipitation, whether the windshield wipers are ON, according to vehicle speed, throttle position, based on readings from the mass airflow sensor 56, based on the air-fuel ratio, based on the detected spark advance, based on pressure within the manifold 46, based on the grade or incline that the vehicle 10 is travelling on, etc.

Accordingly, the system 22 can switch from the “Default Mode” to the “Secondary Mode” under these and/or other certain predetermined conditions to thereby increase the efficiency and to improve the performance of the engine 20. Also, in some embodiments, the system 22 can record the time and conditions triggering the switch from “Default Mode” to “Secondary Mode” and vice versa. This data can be saved in memory (e.g., in the ECM of the vehicle). This data can also be used to analyze the performance of the system 22 and/or to determine whether the system 22 erroneously switched between the “Default Mode” and the “Secondary Mode.”

What is claimed is:

1. An air intake system for a vehicle comprising:
a first inlet defining a first passage that leads to a manifold;
a first valve member that is operably mounted to the first inlet and that moves between an open position and a closed position to regulate flow through the first passage toward the manifold, the first valve member biased toward the open position;
a second inlet defining a second passage that leads to the manifold; a second valve member that is operably mounted to the second inlet and that moves between an open position and a closed position to regulate flow through the second passage toward the manifold, the second valve member biased toward the closed position;
a sensor that detects a condition of the vehicle; and
a controller that simultaneously causes the first valve member to move toward the closed position and the second valve member to move toward the open position when the sensor detects the condition.

2. The air intake system of claim 1, further comprising an actuator that is operably connected to the controller, the actuator operable to actuate the first valve member toward the closed position and to actuate the second valve member toward the open position.

3. The air intake system of claim 2, wherein the actuator includes an electric motor.

4. The air intake system of claim 1, further comprising a linkage with a first portion that is coupled to the first valve member and a second portion that is coupled to the second valve member such that the first valve member and the second valve member move in tandem via the linkage.

5. The air intake system of claim 4, wherein the first portion of the linkage is pivotally attached to the first valve member and the second portion of the linkage is pivotally attached to the second valve member.

6. The air intake system of claim 1, wherein the vehicle defines a front end and a side, wherein the first inlet is open to the side and wherein the second inlet is open to the front end of the vehicle.

7. The air intake system of claim 1, wherein the sensor includes a temperature sensor that is operable to detect whether a temperature exceeds a predetermined threshold.

8. The air intake system of claim 7, wherein the temperature sensor is operable to detect whether an ambient temperature exceeds a predetermined ambient temperature threshold.

9. The air intake system of claim 7, wherein the temperature sensor is operable to detect whether an engine coolant temperature exceeds a predetermined coolant temperature threshold.

10. The air intake system of claim 1, wherein the sensor includes a speed sensor that is operable to detect whether a vehicle speed exceeds a predetermined threshold.

11. A method of operating an air intake system of a vehicle comprising:
providing a first valve member and a second valve member, the first valve member being moveably mounted to a first inlet that defines a first passage that leads to a manifold, the first valve member operable to move between a closed position and an open position, the first valve member being biased toward the open position, the second valve member being moveably mounted to a second inlet that defines a second passage that leads to the manifold, the second valve member being operable to move between a closed position and an open position, the second valve member being biased toward the closed position;
determining whether a predetermined condition of the vehicle exists; and
simultaneously moving the first valve member toward the closed position and the second valve member toward the open position in response to a determination that the predetermined condition of the vehicle exists.

12. The method of claim 11, wherein determining whether the predetermined condition of the vehicle exists includes determining whether a temperature exceeds a predetermined threshold.

13. The method of claim 12, wherein determining whether the predetermined condition of the vehicle exists includes determining whether an ambient temperature exceeds a predetermined ambient temperature threshold.

14. The method of claim 12, wherein determining whether the predetermined condition of the vehicle exists includes determining whether an engine coolant temperature exceeds a predetermined coolant temperature threshold.

15. The method of claim 11, wherein determining whether the predetermined condition of the vehicle exists includes determining whether a vehicle speed exceeds a predetermined threshold.

16. The method of claim 11, wherein determining whether the predetermined condition of the vehicle exists includes determining both whether a coolant temperature exceeds a predetermined coolant temperature threshold and whether a rise over ambient temperature exceeds a predetermined rise threshold.

17. The method of claim 11, wherein determining whether the predetermined condition of the vehicle exists includes determining both whether a vehicle speed exceeds a predetermined speed threshold and whether an ambient temperature exceeds a predetermined ambient temperature threshold.

18. The method of claim 11, wherein the first valve member and the second valve member are connected for simultaneous movement via a linkage such that simultaneously moving the first valve member toward the closed position and the second valve member toward the open position includes driveably moving a single one of the first and second valve member with the linkage forcing the other of the first and second valve member to move.

19. The method of claim 11, wherein the vehicle defines a front end and a side, wherein the first inlet is open to the side and wherein the second inlet is open to the front end of the vehicle.
